(19) United States
(12) Patent Application Publication
(10) Pub. No.: US 2024/0246351 A1
(43) Pub. Date: Jul. 25, 2024

(54) ABLATIVE PRINTED METALLIC LAYER

(71) Applicant: THALES DIS FRANCE SAS, Meudon (FR)

(72) Inventors: Christof SIEGFRIED, GRANICHEN (CH); Christophe BOUSQUET, AURIOL (FR)

(73) Assignee: THALES DIS FRANCE SAS, Meudon (FR)

(21) Appl. No.: 18/566,201

(22) PCT Filed: Jun. 2, 2022
(86) PCT No.: PCT/EP2022/065091

§ 371 Date: Dec. 1, 2023

(30) Foreign Application Priority Data
Jun. 2, 2021 (EP) 21305737.5

(51) Int. Cl. B42D 25/378; B42D 25/351; B42D 25/373; B42D 25/435; B42D 25/45

(52) U.S. Cl. CPC B42D 25/378; B42D 25/351; B42D 25/373; B42D 25/435; B42D 25/45

(57) ABSTRACT

A data carrier comprises at least one substrate layer and at least one processing layer. The substrate layer and the processing layer are arranged at least partially above one another with respect to an extension direction. The substrate layer is at least regionally transparent. The processing layer comprises pigments that are configured to change an appearance, in particular a translucency and/or an opacity and/or a glossiness and/or a colour, upon an irradiation of electromagnetic radiation.

### TECHNICAL FIELD

The present invention relates to a data carrier, to a security document comprising or consisting of such a data carrier, to the use of a processing layer for the manufacturing of a data carrier, to a method of producing a data carrier, and to a method of personalizing and/or of producing a security element in a data carrier.

### BACKGROUND

The provision of security elements or personalisation elements in data carriers are well-known in the state of the art. Security elements serve the purpose of securing the data carrier against unauthorized manipulation such as forgery. Personalization elements serve the purpose of attributing personalized information such as personal data of the holder of the data carrier to the data carrier.

From U.S. Pat. No. 9,174,401 A1 a data carrier comprising an opaque layer sandwiched between a first and a second transparent layer of plastic is known. The opaque layer is provided by a metallized layer that is ablated using a laser, so as to form a second (user) picture, as a copy of a first (user) picture, in a recess. Such a laser ablation allows rendering the opaque layer transparent in the region exposed to the laser. This security element is commonly known as Window Lock (WL) security element, which has been successfully introduced in the market as an effective and secure way to implement, for example, a secondary portrait such as by negative engraving or metal ablation technology, which enables a verification in both incident and transmitted light mode, etc.

However, the manufacturing process is challenging in several respects, since several manufacturing steps, dedicated equipment and costly raw materials are involved, for example.

### SUMMARY

It is an object of the present invention to provide a data carrier that overcomes the drawbacks of the prior art. In particular, it is an object to provide a data carrier that is easy to manufacture and which has a versatile implementation.

This object is achieved with a data carrier according to claim 1. In particular, a data carrier comprising at least one substrate layer and at least one processing layer is provided. The substrate layer and the processing layer are arranged at least partially above one another with respect to an extension direction. The substrate layer preferably is at least regionally transparent. The processing layer comprises pigments that are configured to change an appearance, in particular a translucency and/or an opacity and/or a glossiness and/or a colour, upon an irradiation of electromagnetic radiation.

That is, before an irradiation of electromagnetic radiation the pigments are preferably opaque pigments and/or translucent pigments and/or glossy pigments and/or coloured pigments. Consequently, it is preferred that the processing layer in an untreated state, i.e. before an irradiation of electromagnetic radiation, corresponds to an at least partially translucent or an at least partially opaque layer or an at least partially glossy layer or an at least partially coloured layer, and wherein the irradiation of electromagnetic radiation renders said processing layer in the region of the irradiation more transparent or less opaque or less glossy such as at least partially transparent or of another, i.e. changed colour, for example. A change in glossiness could correspond to a pigment having a glossy metallic appearance in an untreated state becomes matt or dull after the irradiation of the electromagnetic radiation. In other words, an opacity or translucency or glossiness or colour of the pigments and thus of the processing layer in the region of irradiation changes. Again in other words, the pigments and thus the processing layer are preferably configured to exhibit a change in contrast upon the irradiation of electromagnetic radiation. Within the context of the present invention, an opaque pigment (and consequently an opaque processing layer) is understood as being neither transparent nor translucent. The expression transparent is understood as allowing all light to pass through, whereas translucent is understood as allowing some light to pass through. The expression “at least partially transparent” can thus be understood as being translucent or even transparent.

The change in opacity or translucency or glossiness or colour of the processing layer is preferably achieved by ablating the pigments upon an irradiation of electromagnetic radiation. Said electromagnetic radiation is preferably provided by a light source such as a laser. Hence, the pigments are particularly preferably laser-treated, particularly preferably laser-ablated.

To this end it is preferred to at least partially, preferably entirely remove and/or destroy the pigments by the irradiation of the electromagnetic radiation. In particular, upon the irradiation of electromagnetic radiation, a pigment structure of the pigments is at least partially destroyed by the electromagnetic radiation, whereupon remaining pigments in the form of fragments such as droplets, pellets, granules, globules, etc., have an appearance being different from that of the untreated or undestroyed pigments. For instance, the remaining fragments can have different optical characteristics such as a higher transparency when the data carrier is observed in transmission view, e.g. appearing in light grey instead of in dark grey, or a stronger scattering behaviour instead of a mirror-like reflection, e.g. appearing in dark grey instead of a bright metallic luster or silver-effect in incident view, etc.

The laser preferably corresponds to an IR laser. As such, the electromagnetic radiation being irradiated onto the data carrier preferably corresponds to electromagnetic radiation being in the infrared region of the electromagnetic spectrum. However, other lasers such as a UV laser or a RGB laser are likewise conceivable.

The substrate layer being preferably at least regionally transparent is understood as a substrate layer having at least one region where it is transparent. Said transparent region is preferably arranged at least partially in a region of the processing layer with respect to the extension direction. In other words, the transparent region of the substrate layer is preferably at least partially arranged before or after the processing layer with respect to the extension direction. Again in other words, the substrate layer is preferably transparent at least in a subregion of the processing layer. However, it is likewise conceivable that the entire substrate layer is transparent.

Moreover, it should be noted that, in the event of two or more substrate layer (see further below), two or more substrate layers could also be arranged at a same location as the processing layer with respect to the extension direction.

The substrate layer preferably at least partially comprises or consists of at least one plastics and/or of one or more polymers. Said plastics or one or more polymers are preferably transparent. In fact, it is preferred that the substrate layer comprises or consists of at least one thermoplastics and particularly preferably comprises or consists of polycarbonate and/or of polyvinyl chloride and/or of polyethylene terephthalate. Other polymers that are commonly known in the card industry are likewise conceivable.

The pigments preferably are inorganic pigments and/or organic pigments and/or inorganic-organic pigments. Additionally or alternatively, the pigments preferably comprise or consist of one or more metals and/or of one or more oxides preferably metal oxides and/or of one or more alloys preferably metal alloys and/or of one or more ceramics. Additionally or alternatively the pigments preferably comprise or consists of one or more of Al, Cu, Au, Ag, Ti, Zn, Sn, TiN, TiCN, CrN, ZrN, TiZiN, ZrCN, TiC, TiCrN, AlTiN, TiAlN, diamond like carbon, SiO₂, Al₂O₃, CeF₃, ZrO₂, CeO₂, ZnS, TiO₂, SiOₓN_{y} or combinations thereof. Additionally or alternatively, pigments preferably comprise or consist of aluminium and/or brass and/or bronze and/or copper.

That is, various types of pigments are conceivable such as pigments comprising or consisting of aluminium Al and/or copper Cu and/or gold Au and/or silver Ag and/or titanium Ti and/or zinc Zn and/or TiN and/or TiCN and/or CrN and/or ZIN and/or TiZiN and/or ZrCN and/or TiC and/or TiCrN and/or AlTiN and/or TiAlN and/or diamond like carbon and/or SiO₂ and/or Al₂O₃ and/or CeF₃ and/or ZrO₂ and/or CeO₂ and/or ZnS and/or TiO₂ and/or SiOxNy. Particularly preferred pigments are metallic pigments that comprise or consist of aluminium and/or brass and/or bronze and/or copper. However, other types of pigments such as organic pigments, e.g. synthetic organic pigments such as azo pigments or polycyclic pigments, are likewise conceivable and are well-known in the art.

The pigments are preferably commercially available pigments.

The pigments preferably have an average diameter in the range of about 100 nanometer to 500 micrometer, more preferably in the range of about 500 nanometer to 100 micrometer, and particularly preferably in the range of about 1 micrometer to 50 micrometer. Additionally or alternatively the pigments preferably have a thickness with respect to at least one expansion direction running through a respective pigment that is in the range of about 1 nanometer to 1000 nanometer, preferably in the range of about 10 nanometer to 500 nanometer. As an example, pigments having a thickness of 200 nanometer as well as pigments having a thickness of 20 nanometer are well-conceivable. Additionally or alternatively, the pigments preferably have an average diameter of about 100 nanometer or more, preferably of about 500 nanometer or more, and particularly preferably of about 1 micrometer or more. Additionally or alternatively, the pigments preferably have an average diameter of about 500 micrometer or less, preferably of about 100 micrometer or less, and particularly preferably of about 50 micrometer or less.

According to the invention, one or more pigments have a flat shape and/or a disc-like shape. Additionally or alternatively, one or more pigments have an average diameter being larger than a thickness.

That is, the pigments are flat and/or in the form of discs. Additionally or alternatively, the pigments have an average diameter being larger than a thickness. The average diameter of a particular pigment is preferably at least five times or more, more preferably at least ten times or more, most preferably at least hundred times or more than a thickness of said pigment.

The pigments are preferably arranged in a surface region of the processing layer. Additionally or alternatively, the pigments are preferably arranged within the processing layer.

In other words, one or more pigments can correspond to so-called cornflake pigments and/or one or more pigments can correspond to so-called silver dollar pigments and/or one or more pigments can correspond to so-called vacuum metallized pigments. Additionally or alternatively, one or more pigments can correspond to so-called leafing pigments and/or one or more pigments can correspond to so-called non-leafing pigments.

At least one surface of a particular pigment is preferably oriented parallel to a surface of the data carrier, in particular parallel to a surface of the processing layer and/or parallel to a surface of the substrate layer.

In other words, at least one surface of the pigment is preferably aligned or oriented in the same way as the surface(s) of other layers of the data carrier. The surface of the pigments being oriented parallel to the surface of the data carrier, in particular to the surface of the processing layer and the substrate layer, respectively, preferably corresponds to the surface of the pigment having the largest geometrical extent. Said alignment or orientation of the pigments with respect to the surface(s) is preferably a consequence of a chemical and/or physical environment of the pigments such as a type of ink within which the pigments can be provided, a viscosity of the ink within which the pigments can be provided, a type of solvent within which the pigments can be provided, etc. In fact, and as will be explained in greater detail below, the processing layer preferably comprises at least one ink, wherein the achievement of an alignment or orientation of the pigments is well-known to the skilled person in the field of printing.

A thickness of the processing layer with respect to the extension direction preferably is in the micrometer range such as between 0.5 micrometer to 10 micrometer such as between 1 micrometer and 2 micrometer. However, other thicknesses are likewise conceivable.

The processing layer is preferably printed and/or provided as coating and/or sprayed on. Additionally or alternatively, the processing layer preferably comprises at least one ink, preferably a solvent-based ink and/or a curable ink. The ink particularly preferably is a printing ink, preferably a solvent-based printing ink and/or a curable printing ink. However, other inks are likewise conceivable. For instance, a solvent-based ink could be sprayed on. Another example involves a curable ink that is cured oxidative, etc. Additionally or alternatively, the processing layer at least in an initial state preferably comprises one or more dissolved polymers.

The pigments are particularly preferably dispersed in a printing ink and/or in a coating ink and/or in a spraying ink. In other words, it is preferred that the processing layer is provided by a dispersion comprising at least one printing ink and/or coating ink and/or spraying ink and the pigments. Said dispersion is particularly preferably printed, e.g. printed on one or more of the substrate layers and/or on further layers of the data carrier such as on one or more background layers, see further below. Hence, it is preferred that the processing layer is printed onto one or more layers of the data carrier such as onto one or more of the substrate layers and/or onto one or more further layers of the data carrier such as on one or more background layers, see further below. In other words, the processing layer is preferably provided by means of a printing ink, preferably a silk-screen printing ink, and the pigments.

The processing layer preferably is silk-screen printed and/or flexographic printed and/or gravure printed and/or letterpress printed and/or letterset printed and/or pad printed, etc. However, in addition or in alternative to these printing methods, other application methods are likewise conceivable, such as coating methods or spray methods. These methods are preferably methods as they are known in the art. The preferred printing technique is silk-screen printing as it is known in the art.

To this end it is preferred to apply or set conditions as they are known in the art, e.g. a preferred viscosity of the printing ink preferably corresponds to a viscosity as it is used in the printing ink technology, etc.

A concentration of the pigments in the ink, preferably in the printing ink, particularly preferably in the silk-screen printing ink is preferably chosen according to the ink characteristics and/or the ink drying characteristics and/or an adhesion of the ink such as the silk-screen printing ink to the layer(s) the (silk-screen) printing ink is to be applied on such as the substrate layer(s) and/or a desired visual effect (e.g. desired opacity of the processing layer) and/or a behavior in laser ablation.

A concentration of the pigments in the ink, preferably in the printing ink such as the silk-screen printing ink preferably is in the range of 0.1% by weight per total weight of the ink to 50% by weight per total weight of the ink, more preferably in the range of 1% by weight per total weight of the ink to 10% by weight per total weight of the ink. Additionally or alternatively a concentration of the pigments in the ink preferably is at least 0.1% by weight per total weight of the ink or more, more preferably at least 1% by weight per total weight of the ink or more.

It should be noted that the above explanations likewise apply to the case where one or more coating inks and/or one or more spraying inks are used.

The printing ink preferably corresponds to a solvent-based printing ink such as a solvent-based silk-screen printing ink and/or a curable printing ink such as a curable silk-screen printing ink, the curable printing ink particularly preferably being UV curable.

A solvent-based printing ink is configured to dry by an evaporation of its solvent(s). After the evaporation of its solvent(s) the other components of the printing ink such as its thermoplastics, the pigments and possibly further compounds such as a binder remain in the data carrier. In this way a plastic-like layer remains, in particular a PC-like layer in the event that the substrate layer comprises polycarbonate, a PVC-like layer in the event that the substrate layer comprises polyvinyl chloride, a PET-like layer in the event that the substrate layer comprises polyethylene terephthalate, etc.

A curable printing ink is configured to dry, or cure, by the formation of a crosslinked network of its polymers. To this end it is conceivable that the processing layer is either based on a solvent-based screen printing ink or on a curable screen printing ink or on a mixture thereof. It is furthermore preferred that the printing ink comprises one or more binders and/or one or more additives such as photoinitiators.

The binder is preferably chosen so as to provide sufficient adhesion to the layer(s) the processing layer is applied to, e.g. the substrate layer.

The binder is preferably further chosen such as to be compatible with the plastics, in particular the polycarbonate, constituting the substrate layer.

The presence of one or more photoinitiators is preferred if the printing ink is configured to cure by a radical polymerization.

The printing ink, at least in an initial state, i.e. in a state of its application onto one or more layers of the data carrier, preferably comprises one or more dissolved polymers. In other words, the processing layer, at least in the initial state, preferably comprises one or more dissolved polymers. Said one or more polymers are preferably dissolved in at least one solvent of a solvent-based printing ink. Said one or more polymers furthermore preferably comprise or consist of one or more thermoplastics, particularly preferably one or more polycarbonates and/or polyvinyl chlorides and/or polyethylene terephthalates, etc. After the evaporation of the solvent(s), said originally dissolved polymers remain in the data carrier. The processing layer preferably comprises one or more printing inks that are commercially available. For example, a preferred processing layer comprises polycarbonate and is furthermore generated with the commercially available printing ink “Additive TP PUD7033” from the company Covestro. Said printing ink corresponds to an organic, halogen-free polycarbonate solution used to produce inkjet inks for printing on films. Another example is the commercially available printing ink “Additive TP PUD7395-2” from the company Covestro. Said printing ink corresponds to an organic, halogen-free polycarbonate solution used to produce screen printing inks and adhesives for films. To this end it is particularly preferred to use a combination of two or more printing inks, such as a mixture of “Additive TP PUD7033” and “Additive TP PUD7395-2”. These two printing inks or varnishes are preferably mixed together in order to obtain a desired viscosity of the resultant mixture. In other words, it is preferred to use two or more printing inks of different viscosities and/or solvent contents in order to adjust a desired viscosity of the resultant mixture to be applied as processing layer in the data carrier. Another example of a commercially known printing ink is “Noriphan HTR N” from the company Pröll. Said printing ink corresponds to a laminable screen printing ink for PC cards and is a solvent-based screen printing ink system for printing on PC foils for card production. It furthermore contains a high-temperature resistant thermoplastic binder.

A size of the pigments is preferably chosen according to the printing conditions to be applied and/or according to a desired visual effect and/or according to a desired behaviour in laser ablation.

The substrate layer and the processing layer are preferably in connection with one another or connected to one another via lamination. Additionally or alternatively, the processing layer and/or the substrate layer are heat-resistant, preferably up to a temperature of at least 100° C. or more, preferably of at least 135° C. or more, more preferably of at least 150° C. or more, particularly preferably of at least 180° C. or more.

The substrate layer and the processing layer being connected to one another means that these layers are in immediate or direct contact with one another. In other words, these layers are at least partially arranged on top of one another. Again in other words, no further components such as an adhesive or no further layers are arranged between them. In contrast, a substrate layer and a processing layer being in connection with one another means that they are not in direct or immediate contact with one another, e.g. because there are one or more further layers arranged between them. Hence, the processing layer can arranged and/or applied directly or indirectly on the substrate layer or vice versa.

It is furthermore preferred that the processing layer and the substrate layer are laminated. It is furthermore preferred that the connection of these layers is purely based on lamination, i.e. it is preferred that no further connection means such as an adhesive are present. The processing layer and the substrate layer are thus preferably in connection or connected to one another permanently, i.e. irreversibly. In other words, the processing layer and the substrate layer cannot be separated from one another without the data carrier being destroyed.

The expression “heat resistant” means, that the processing layer and/or the substrate layer do not thermally degrade up to a temperature being applied during the production of the data carrier, in particular during the lamination as mentioned above. In other words, the temperature used in the lamination shall not thermally degrade the processing layer according to the invention and/or the substrate layer, e.g. the temperature used in the lamination preferably does not yellow or does not form bubbles or the like in the processing layer and/or the substrate layer.

The substrate layer and the processing layer are preferably arranged partially or completely overlapping with respect to the extension direction. Additionally or alternatively, an expansion of the substrate layer along a transverse direction running perpendicularly to the extension direction and an expansion of the processing layer running along the transverse direction are preferably the same or different from one another. Additionally or alternatively, the data carrier 1 preferably comprises two or more substrate layers.

The extension direction can be seen as a vertical direction of the data carrier and the transverse direction can be seen as a horizontal direction of the data carrier.

Different arrangements and/or configurations of the substrate layer(s) and the processing layer(s) are conceivable. For instance, an expansion of the substrate layer and the processing layer along the transverse direction can be the same or different. In other words, a width of these layers along the horizontal direction can be the same or different. Moreover, it is conceivable that these layers are arranged only partially overlapping with respect to the extension direction. In other words, when seen along the vertical direction, at least a region of the processing layer is not covered by the substrate layer or vice versa. However, it is likewise conceivable that these layers are entirely overlapping with respect to the extension direction. In this case, the processing layer entirely covers the substrate layer or vice versa when seen along the vertical direction.

The data carrier can comprise two or more substrate layers. Additionally or alternatively the data carrier can comprise two or more processing layers. Said two or more substrate layers can be the same or different from one another. Likewise, said two or more processing layers can be the same or different from one another.

A difference could lie in the overlapping with respect to the extension direction and/or in the expansion along the transverse direction, for example. For instance, it is conceivable that one or more substrate layers are arranged only partially overlapping with one or more processing layers with respect to the extension direction, whereas one or more further substrate layers are entirely overlapping with one or more processing layers with respect to the extension direction. Additionally or alternatively, an expansion or width of one or more substrate layers along the transverse direction or horizontal direction can be the same as an expansion or width of one or more processing layers along the transverse direction or horizontal direction, whereas an expansion or width of one or more substrate layers along the transverse direction or horizontal direction can be the different from an expansion or width of one or more processing layers along the transverse direction or horizontal direction.

The data carrier preferably further comprises at least one background layer. The background layer preferably is opaque and/or configured to at least partially reflect incident electromagnetic radiation and/or configured to at least partially absorb incident electromagnetic radiation. Additionally or alternatively, the background layer is preferably arranged before or after or at a same location as the substrate layer and/or the processing layer with respect to the extension direction. Additionally or alternatively, an expansion of the background layer along a transverse direction running perpendicularly to the extension direction and an expansion of the processing layer running along the transverse direction and/or an expansion of the substrate layer running along the transverse direction are preferably the same or different from one another.

That is, the data carrier can furthermore comprise at least one background layer. Said background layer is preferably not transparent or not translucent such as opaque. The background layer preferably comprises or consists of one or more polymers and/or plastics, preferably thermoplastics, particularly preferably polycarbonate. The background layer preferably furthermore corresponds to a coloured layer such as a white layer. Such a coloured background layer is preferably provided by a layer comprising or consisting of polymers and/or plastics, within which pigments are embedded. Said pigments are preferably opaque and/or configured to at least partially reflect incident electromagnetic radiation and/or configured to at least partially absorb incident electromagnetic radiation. The background layer preferably serve the purpose of rendering the data carrier at least partially opaque and/or of providing a background for the data carrier that is not transparent but of a colour. The background layer preferably is of a white colour. However, other colours are likewise conceivable.

Different arrangements of the background layer with respect to the processing layer and the substrate layer are conceivable, as well. For instance, an expansion of the background layer and the processing layer and/or the substrate layer along the transverse direction can be the same or different. In other words, a width of these layers along the horizontal direction can be the same or different. Moreover, it is conceivable that these layers are arranged only partially overlapping with respect to the extension direction. In other words, when seen along the vertical direction, at least a region of the processing layer and/or of the substrate layer is not covered by the background layer or vice versa. However, it is likewise conceivable that these layers are entirely overlapping with respect to the extension direction or with respect to a direction running opposite to the extension direction.

In the case that the background layer is arranged a same location as the substrate layer and/or the processing layer with respect to the extension direction, it is preferred that the background layer comprises at least one recess or through-hole or opening, and wherein the processing layer and/or the substrate layer is arranged at least partially within said recess or through-hole or opening. Said recess or through-hole or opening can be a window as described in US 2014/023 838 A1. In other words, it is conceivable that the processing layer according to the invention is implemented as the well-known Window Lock, however with the difference that the metallic foil is replaced by the processing layer comprising the opaque pigments according to the invention.

Moreover, it is conceivable that the data carrier comprises two or more background layers, wherein said two or more background layers are the same or different from one another. Also in this case, a difference lie in the overlapping with respect to the extension direction and/or in the expansion along the transverse direction, for example, as has been outlined above.

One or more processing layers and/or one or more substrate layers and/or one or more background layers can be continuous layers with respect to the transverse direction. A continuous layer is understood as a layer having no gaps or interruptions or the like. However, it is likewise conceivable that one or more processing layers and/or one or more substrate layers and/or one or more background layers are interrupted, i.e. provided in segments, with respect to the transverse direction. A distance between successive segments with respect to the transverse direction can be the same or different from one another. In other words, segments of the processing layer(s) and/or of the substrate layer(s) and/or of the background layer(s) can be arranged evenly or unevenly spaced from each other and with respect to the transverse direction. As a consequence, different overlappings of these segments with respect to the extension direction can be generated, as well.

The data carrier preferably furthermore exhibits at least one blackening effect. Said blackening effect is preferably provided in a region of the processing layer. The blackening effect is preferably generated upon the irradiation of the electromagnetic radiation on the processing layer.

This allows new general personalization effects, e.g. the generation of a second photo in a region of the processing layer, and/or improves effects in connection with a lens structure, e.g. it enables significantly sharper tilting effects by providing a better coordination with a focus of the lens structure, see further below.

The processing layer is preferably part of or constitutes at least one security element and/or at least one personalization element. The security element and/or the personalization element preferably has the shape of an image and/or of an alphanumeric character.

Non-exhaustive examples of an image are a portrait or photograph or biometric information such as a fingerprint e.g. of the holder of the data carrier, an outline of a country, a state coat of arms, a state flag, a signature panel, geometric objects such as lines, circles, etc. Non-exhaustive examples of an alphanumeric character are a date of birth, a name, a social security number e.g. of the holder of the data carrier, an expiry date, etc.

A security element can serve the purpose of securing the data carrier against unauthorized manipulation such as forgery.

A personalization element can serve the purpose of attributing personalized information such as personal data of the holder of the data carrier to the data carrier.

Hence, it is particularly preferred that the processing layer is laser-treated so as to generate a security element and/or a personalization element. Said laser-treatment preferably corresponds to an at least partial removal or destruction of the pigments as mentioned above.

Depending on the arrangement and/or the configuration of the processing layer(s) and/or the substrate layer(s) and/or the background layer(s) the security element and/or the personalization element can be visible upon an illumination of the data carrier along an observation direction or upon an illumination of the data carrier along a direction running opposite to the observation direction.

The observation direction is understood as the direction along which an observer observes the data carrier. Said observation direction runs towards a top side or top surface of the data carrier. Hence, the top side or top layer or top surface of data carrier is understood as the side or layer or surface of the data carrier that is facing an observer of the data carrier. A bottom side or bottom layer or bottom surface of the data carrier is thus understood as the opposite side or layer or surface of the data carrier, i.e. the side or layer or surface facing away from an observer of the data carrier.

The security element can be a positive security element or a negative security element. Likewise, the personalization element can be a positive personalization element or a negative personalization element. The expressions “positive” and “negative” have the same meaning as in photography, wherein a negative image is an image wherein the lightest areas appear darkest and the darkest areas appear lightest, and wherein a positive image is a normal image.

Hence, a positive security element or positive personalization element is understood as being a normal image and/or a normal alphanumeric character that appears under illumination of the data carrier along the observation direction, i.e. when the data carrier is illuminated from a top side of the data carrier. Consequently, a negative security element or a negative personalization element is understood as a negative image and/or a negative alphanumeric character upon an illumination of the data carrier along the observation direction, which, in case of a transparent background such as a transparent background layer or window however appear as positive image and/or as positive alphanumeric character upon an illumination of the data carrier along a direction running opposite to the observation direction, i.e. when the data carrier is illuminated from a bottom side of the data carrier.

For instance, in the event of a personalization element or a security element being provided in a transparent region of the data carrier, a change from an illumination from the top side of the data carrier to an illumination from the bottom side of the data carrier leads to a reversal of the visual impression of said personalization element or security element, namely from negative to positive or vice versa. Furthermore, and depending on the type of data used for generating the personalization element or the security element, said elements can be positive or negative with both types of illumination, i.e. top side and bottom side illumination. In this regard it is preferred to use digital data, e.g. photo data for the personalization process. This data can be negative or positive, depending on the visual effect one wants to achieve on the personalized data carrier. For instance, when the personalized photo should appear positive in transmission view, the digital photo data used for the laser ablation process needs to be negative, as “black” data will be lasered, and since “white” data will not be lasered.

In the event of a non-transparent background such as a white background layer the security element and/or personalization element is preferably constituted by positive data becoming visible or appearing upon an illumination of the data carrier from a top side of the data carrier.

The data carrier preferably further comprises at least one lens structure comprising one or more lenses, particularly preferably one or more lenticular lenses. Said lens structure is preferably configured to alter an appearance of the processing layer, in particular of the security element and/or of the personalization element. Additionally or alternatively, said lens structure is preferably configured to focus incident electromagnetic radiation.

That is, the lens structure preferably serves the purpose of focusing incoming electromagnetic radiation such as light, for example ambient light, onto particular regions within the data carrier, in particular onto different regions of the processing layer, and particularly preferably onto different regions of the security element and/or the personalization element. Hence, those parts of the data carrier, in particular of the processing layer or the security element or the personalization element, where the incoming light has not been focused to will not be illuminated. In other words, the lens structure is preferably configured to selectively illuminate the processing layer, the security element and the personalization element, respectively, when the data carrier is exposed to light such as ambient light. This partial or selective illumination confers a changing appearance to the data carrier, in particular to the processing layer and particularly preferably to the security element and/or the personalization element. The appearance furthermore preferably changes in dependence of an angle of observation under which an observer observes the data carrier. That is, the lens structure allows the generation of tilting effects and/or flip-effects and/or movement effects and/or transformations and/or 3D effects and/or Moiré-effects, etc., wherein an appearance is generated in dependence of a tilting. It should be noted that all of these dynamic effects are generated by tilting the data carrier, wherein there is usually always a visible “image” or the like (i.e. an image will be visible in the event that the security element or the personalization element corresponds to an image) present at every angle of observation, meaning no tilting will result in a static effect of the data carrier. For instance, a Moiré-effect could be generated by providing a security element in the form of a line pattern, and wherein said line pattern in combination with the lens structure results in a Moiré effect when the data carrier is tilted.

The lens structure is preferably arranged on the top side of the data carrier and/or on the bottom side of the data carrier. That is, the lens structure is preferably the uppermost and/or the lowermost component of the data carrier with respect to the extension direction or the vertical direction. As such, the lens structure is preferably arranged before the substrate layer(s), the processing layer(s) and the background layer(s).

Additionally or alternatively, the lens structure is preferably arranged after the substrate layer(s), the processing layer(s) and the background layer(s).

The lens structure can be produced on the data carrier during lamination of the data carrier. In doing so, the lens structure could be moulded from an embossing template onto the layer constituting the top side, i.e. a top layer, or the bottom side, i.e. a bottom layer of the data carrier.

In another aspect a security document comprising or consisting of at least one data carrier as described above is provided. The security document preferably is an identity card, a passport, a credit card, a smart card, a driving license, a data page or the like.

It should be understood that the data carrier per se can correspond to a security document. This is the case if the data carrier is provided in the form of an identity card, for example. However, it is likewise conceivable to introduce or incorporate the data carrier into a security document. In the case of a passport for example the data carrier could correspond to or could be incorporated in a page of the passport.

Any explanations provided with regard to the data carrier per se likewise apply to the security document and vice versa.

In another aspect a use of a processing layer for the manufacturing of a data carrier is provided, wherein the processing layer comprises pigments that are configured to change an appearance, in particular a translucency and/or opacity and/or glossiness and/or a colour, upon the irradiation of electromagnetic radiation.

The processing layer preferably corresponds to a processing layer as described above. The data carrier preferably corresponds to a data carrier as described above. Any explanations provided with regard to the processing layer or the data carrier thus likewise apply to the use of these components and vice versa.

In another aspect, a method of producing a data carrier, preferably a data carrier as described above, is provided. The method comprises the steps of i) providing at least one substrate layer, and ii) providing at least one processing layer. The substrate layer and the processing layer are arranged at least partially above one another with respect to an extension direction. The substrate layer is at least regionally transparent. The processing layer comprises pigments that are configured to change an appearance, in particular a translucency and/or an opacity and/or a glossiness and/or a colour, upon an irradiation of electromagnetic radiation.

It is preferred that at least one substrate layer is preferably provided before the at least one processing layer is provided. That is, it is preferred to generate one or more substrate layers in a first step and to then generate one or more processing layers in a subsequent second step.

Any explanations provided with regard to the data carrier per se likewise apply to the method of producing a data carrier and vice versa. For instance, it is preferred that the processing layer is printed and/or provided as coating and/or sprayed onto one or more substrate layers. It is furthermore preferred that these layers are connected to one another via lamination, etc.

In a further aspect a method of personalizing a data carrier and/or of producing a security element in a data carrier is provided. The method comprises the steps of i) providing a data carrier as described above, and ii) irradiating electromagnetic radiation onto the data carrier so as to change an appearance, in particular the translucency and/or opacity and/or glossiness and/or a colour of the pigments.

Here again it is noted that any explanations provided with regard to the data carrier per se likewise apply to the method of its personalization or production of a security element and vice versa.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows a top partial view on a data carrier comprising a security element and a personalization element according to a first embodiment;

FIG. 2 shows a top partial view on a data carrier comprising a security element and a personalization element according to another embodiment;

FIG. 3 shows a sectional view of a substrate layer;

FIG. 4 shows a sectional view of a data carrier comprising substrate layers, background layers and a processing layer according to a first embodiment;

FIG. 5 shows a sectional view of a data carrier comprising substrate layers, background layers and a processing layer according to another embodiment;

FIG. 6 shows a sectional view of a data carrier comprising substrate layers, background layers and a processing layer according to another embodiment;

FIG. 7 shows a sectional view of a data carrier comprising substrate layers, background layers and a processing layer according to another embodiment.

### DETAILED DESCRIPTION

Various aspects of the data carrier 1 according to the invention shall now be described with respect to the figures.

All data carriers 1 according to the invention have in common that they comprise at least one substrate layer 2, 2a, . . . and at least one processing layer 3, wherein the substrate layer 2, 2a, . . . and the processing layer 3 are arranged at least partially above one another with respect to an extension direction E. Furthermore, the substrate layer 2, 2a, . . . is at least regionally transparent and the processing layer 3 comprises pigments 4 that are configured to change an appearance such as a translucency and/or an opacity and/or a glossiness and/or a colour upon an irradiation of electromagnetic radiation, whereby at least one security element 14 and/or at least one personalization element 15 is generated. Hence, the processing layer 3 is part of or constitutes at least one security element 14 and/or at least one personalization element 15. Said security element 14 and/or the personalization element 15 preferably has the shape of an image and/or of an alphanumeric character.

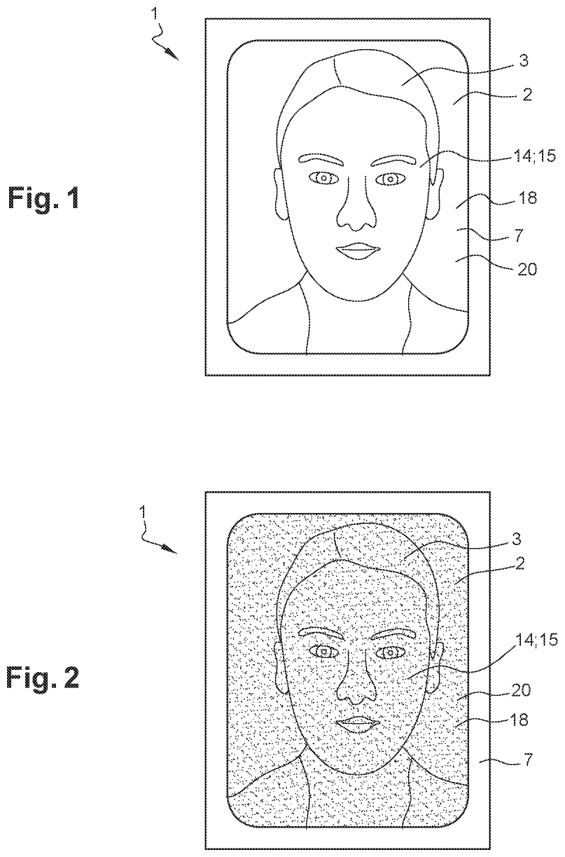

FIGS. 1 and 2 depict two examples of a data carrier 1 comprising a security element 14 and a personalization element 15 according to the invention. Here, said security elements 14 and personalization elements 15 are provided in each case by means of a single element, namely the image of a woman. Further information of said security elements or personalization elements, respectively, will be given further below. At this point it is merely noted that FIG. 1 corresponds to an example of a data carrier 1 comprising a security element 14 or personalization element 15 being visible in transmission view, i.e. upon illumination of the data carrier 1 from a bottom side 19 of the data carrier 1, whereas FIG. 2 corresponds to an example of a data carrier 1 comprising a security element 14 or personalization element 15 being visible in opaque view, i.e. upon illumination of the data carrier 1 from a top side 18 of the data carrier 1. The observation direction along which an observer observes these data carriers 1 is in each case the same, namely an observation of the top side 18 of the data carrier 1. The security element 14 or personalization element 15 depicted in FIG. 1 corresponds to a positive security element 14 or a positive personalization element 15 as it appears or becomes visible upon an illumination of the data carrier 1 from the bottom side 19 of the data carrier 1, i.e. in transmission view. Consequently, the security element or personalization element would appear negative when illuminated from the top side/with incident light. This is in contrast to the security element 14 or personalization element 15 depicted in FIG. 2, which is a positive security element 14 or personalization element 15 becoming visible or appearing upon an illumination of the data carrier 1 from the top side 18 of the data carrier 1, i.e. in opaque view. It should be noted that FIG. 2 depicts an example of a data carrier having a white background layer and exhibiting blackening effects (see further below), wherein positive digital photo data was used for the laser personalization.

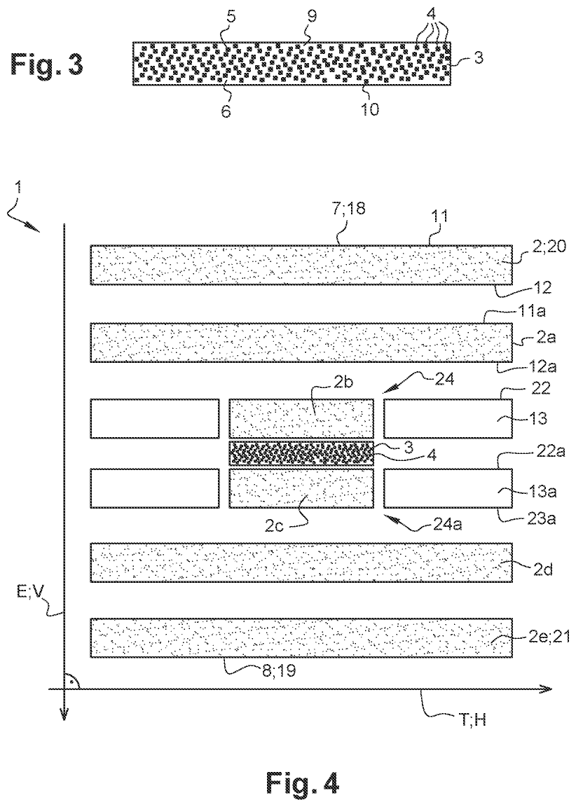

FIG. 3 depicts a processing layer 3 according to the invention. Said processing layer 3 comprises one or more polymers, within which a plurality of pigments 4 are arranged. The processing layer 3 defines a top surface 9 and an opposing bottom surface 10. Furthermore, in the depicted example, the pigments 4 are evenly distributed within the processing layer 3 and are arranged in surface regions 5, 6 of the processing layer 3 as well as within the processing layer 3. Although not visible, the pigments 4 are of a flat or disc-like shape and have an average diameter being much larger than a thickness. In addition, and as also not evident from the figures, the pigments 4 comprise at least one surface, here because of its disc-like or flat shape two surfaces, that are oriented parallel to the top and bottom surfaces 9, 10 of the processing layer 3. The pigments 4 are configured and arranged within the processing layer 3 such that, when said processing layer 3 is arranged in the data carrier 1, said surfaces of the pigments 4 are oriented parallel to other surfaces 7, 8, 9, 10, 11, 11a, . . . , 12, 12a, . . . , 22, 22a, . . . , 23, 23a, . . . of the layers 2, 2a, . . . , 3, 13, 13a, . . . of the data carrier 1 as well. In particular, the surfaces of the pigments 4 are oriented parallel to the surfaces 11, 11a, . . . ; 12, 12a, . . . of the substrate layers 2, 2a, . . . , as well as parallel to the surfaces 22, 22a, . . . , 23, 23a, . . . of the background layers 13, 13a, . . . , see below.

In all depicted embodiments, the processing layer 3 is printed or applied as a coating or sprayed on one or more layers of the data carrier 1. Furthermore, the layers are configured such, that they can be connected to one another via lamination. In fact, the layers are stacked on one another in a first step and then subjected to a lamination process in order to connect the layers to one another in a subsequent second step.

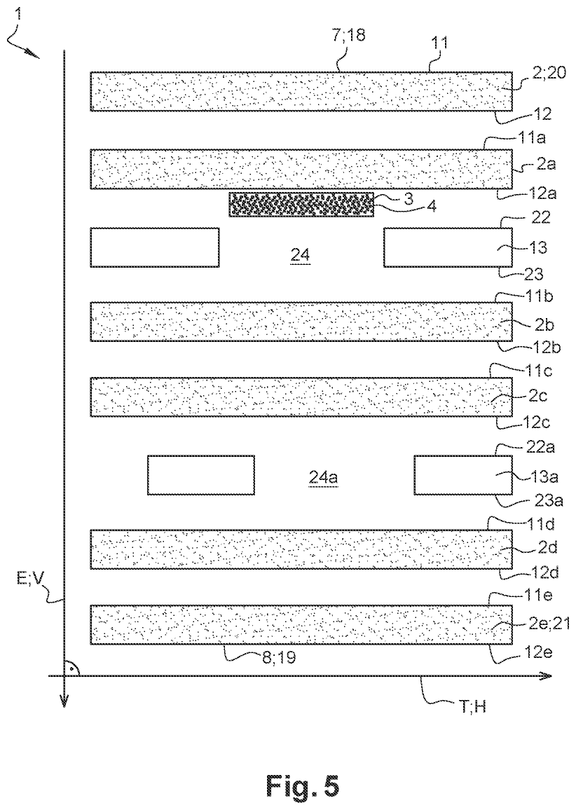

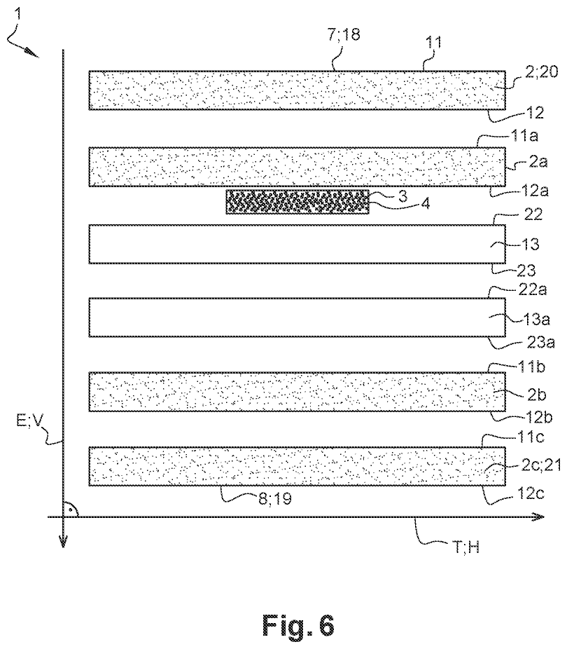

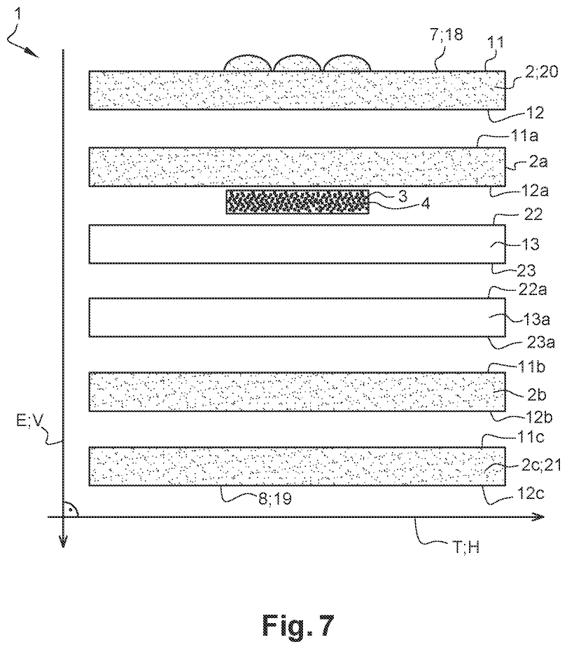

In all depicted embodiments, the uppermost or top layer 20 and the lowermost or bottom layer 21 of the data carrier 1 in each case are provided by a substrate layer 2, 2e. That is, the uppermost or top substrate layer 2, 20 forms a top side 18 of the data carrier 1 and defines a top surface 7 of the data carrier 1, and the lowermost or bottom substrate layer 2e, 21 forms a bottom side 19 of the data carrier 1 and defines a bottom surface 8 of the data carrier 1. Moreover, all data carriers 1 comprise several substrate layers 2, 2a, . . . , namely six substrate layers 2, 2a, 2b, 2c, 2d, 2e in the embodiments depicted in FIGS. 4 and 5, and four substrate layers 2, 2a, 2b, 2c in FIGS. 6 and 7. In all of these examples, the substrate layers 2, 2a, . . . are entirely transparent. That is to say, all regions of the substrate layers 2, 2a, . . . are transparent. Nevertheless, also in this case each substrate layer 2, 2a, . . . can be said to have at least one region where it is transparent and which transparent region is arranged in a region of the processing layer 3, in fact before and/or after the processing layer 3 with respect to the extension direction E. However, it should be noted that the substrate layers does not need to be entirely transparent. For instance, one or more substrate layers could be coloured, in particular coloured translucent. Moreover, all depicted data carriers 1 comprise background layers 13, 13a, namely in each case two background layers 13, 13a. Here, said background layers 13, 13a correspond to polycarbonate layers of white colour, i.e. the background layers 13, 13a being opaque and being configured to at least partially reflect incident electromagnetic radiation.

As becomes readily apparent from a comparison of FIGS. 4 to 7, various arrangements and designs of the layers 2, 2a, . . . , 3, 13, 13a are conceivable. For instance, FIG. 4 depicts a data carrier 1 comprising, in this sequence along the extension direction E, two substrate layers 2, 2a being arranged after one another, a segmented background layer 13 within which segments another substrate layer 2b is arranged, followed by a processing layer 3, which processing layer 3 is followed by another segmented background layer 13a within which segments another substrate layer 2c is arranged, and which layers are in turn followed by another two substrate layers 2d, 2e. Hence, the background layers 13, 13a and the substrate layers 2b, 2c arranged there between as well as the processing layer 3 are arranged after the two uppermost substrate layers 2, 2a and before the two lowermost substrate layers 2d, 2e with respect to the extension direction E. The background layers 13, 13a and the substrate layers 2b, 2c arranged there between are said to be located at a same location with respect to the extension direction E, i.e. they are arranged at a same height within the data carrier 1. Furthermore, an extension of the two uppermost substrate layers 2, 2a and of the two lowermost substrate 2d, 2e layers along a transverse direction T running perpendicularly to the extension direction E is in each case the same. The extension direction E can be seen as a vertical direction V of the data carrier 1 and the transverse direction T can be seen as a horizontal direction H of the data carrier 1. In other words, these substrate layers 2, 2a, 2d, 2e have a same width along the transverse direction T or the horizontal direction H, respectively. The same applies to the extension of the two innermost substrate layers 2b, 2c being arranged between the segments of the background layers 13, 13a as well as to the extension of the processing layer 3. This extension however is smaller than the extension of the uppermost and lowermost substrate layers 2, 2a, 2d, 2e.

In the data carrier 1 depicted in FIG. 5, however, all substrate layers 2, 2a, 2b, 2c, 2d, 2e have a same extension or width along the transverse direction T, which extension or width is furthermore different from an extension or width of the background layers 13, 13a and the processing layer 3. Moreover, whereas the substrate layers 2-2e are arranged so as to entirely overlap one another with respect to the extension direction E, the segments of the upper background layer 13 and the segments of the lower background layer 13a of the data carrier 1 depicted in FIG. 5 only partially overlap one another with respect to the extension direction E. In fact, the segments of the upper background layer 13 have a width or extension along the transverse direction T being larger than the width or extension of the segments of the lower background layer 13a. Moreover, in this depicted state of the data carrier 1, the left segment of the upper background layer 13 and the left segment of the lower background layer 13a are arranged staggered with respect to one another and with respect to the extension direction E. Moreover, the segments of each background layer 13, 13a are arranged at a distance from one another and with respect to the transverse direction. In other words, they define a gap or recess or opening 24, 24a between one another. When seen along the extension direction E, the processing layer 3 is arranged in the region of said gap or distance or recess or opening 24. In other words, when the data carrier 1 is observed along the extension direction E or along a direction running opposite to the extension direction, the processing layer 3 is not covered by the background layers 13, 13a.

The data carriers 1 depicted in FIGS. 6 and 7 comprise substrate layers 2-2c and unsegmented or continuous background layers 13, 13a whose extension along the transverse direction T is in each case the same. In both examples, the processing layer 3 is arranged after two entirely transparent substrate layers 2, 2a when seen along the extension direction E and it is furthermore in each case followed by two background layers 13, 13a. That is, and in contrast to the examples depicted in FIGS. 4 and 5, the background layers 13, 13a cover the processing layer 3 when seen along a direction running opposite to the extension direction E.

The data carriers 1 depicted in FIGS. 6 and 7 exhibit blackening effects. Said blackening effects are generated in a region of the processing layer 3. The blackening effect is generated upon the irradiation of the electromagnetic radiation on the processing layer 3. Regarding an observation of the data carrier in transmitted light, the laser ablation causes a reduction in opacity (or an increase in transparency), or in other words, changes an appearance from a dark gray to a light gray. Other colour changes are of course likewise conceivable. For instance, in the event of a coloured translucent substrate layer a colour change from blue to grey or blue to clear could take place, depending, inter alia, on the colour of the substrate layer. The security element or the personalization element, respectively, are recognizable through the contrast difference thus achieved.

When the data carrier is observed in top view (in incident light), the laser ablation destroys the typical, bright metallic luster (lack of metallic reflection) and instead creates a gray color impression. The contrast between light metallic and dark gray areas makes the security element or the personalization element recognizable, whereby the contrast becomes stronger the closer said elements are to a reflective background (the gray appears darker, the less light penetrates through the said element from behind). The reflective background can be, for example, a table top in the event that the data carrier is placed on a table top (in the case of the transparent version of the element analogous to the Window Lock), or a background layer such as a white background foil (in the case of the opaque version of the element). This allows new personalization or security effects, e.g. the generation of a second photo in the region of the processing layer 3, and/or improves effects in connection with a lens structure 16, e.g. it enables significantly sharper tilting effects by providing a better coordination with a focus of the lens structure 16, see also further below.

The data carrier 1 depicted in FIG. 7 furthermore comprises a lens structure 16 which is constituted here by lenticular lenses 17. Said lens structure 16 is configured to alter an appearance of the processing layer 3, in particular of the security element 14 and the personalization element 15, respectively. The lens structure 16 is furthermore configured to focus incident electromagnetic radiation at a location within the data carrier 1 and with respect to the extension direction E and/or the transverse direction. T Various alterations of the appearance are enabled in this way. For instance, and depending on the particular design of the security element 14 or the personalization element 15, respectively, tilting effects and/or flip-effects and/or movement effects and/or transformations and/or 3D effects and/or Moiré-effects are generated. In the depicted example, the lens structure 16 is arranged on the top side 18 of the data carrier 1, i.e. on the top surface 7 of the uppermost substrate layer 2.

As mentioned initially with respect to FIGS. 1 and 2, the security element 14 and/or the personalization element 15 can be visible upon an illumination of the data carrier 1 along the observation direction, i.e. upon an illumination of a top side 18 of the data carrier 1, or upon an illumination of the data carrier 1 along a direction running opposite to the observation direction, i.e. upon an illumination of the bottom side 19 of the data carrier 1.

This particular visibility depends on the arrangement and/or the configuration of the processing layer(s) 3 and/or the substrate layer(s) 2, 2a, . . . and/or the background layer(s) 13, 13a such as background layers 13, 13a entirely uncovering or revealing the processing layer 3 with respect to the extension direction E and the direction running opposite to the extension direction E (FIGS. 4 and 5), background layers 13, 13a covering the processing layer 3 with respect to the direction running opposite to the extension direction E (FIGS. 6 and 7), a processing layer 3 being sandwiched between two transparent substrate layers 2b, 2c so as to form an insert device and which insert device being inserted in the gap or recess or opening 24 formed between the background layers 13, 13a (FIG. 4), etc. In other words, the present invention enables an implementation in analogy to the Window Lock technique, wherein the insert device being constituted here by two transparent substrate layers 2b, 2c and the processing layer 3 arranged there between is arranged in the gap or recess or opening 24 that can be seen as a window as described in US 2014/023 838 A1. Hence, in terms of terminology being common in the state of the art, the data carrier 1 depicted in FIG. 4 can be seen as a polycarbonate (PC) structure having a window insert being translucent. FIG. 5 depicts another example of a polycarbonate (PC) translucent structure, wherein the processing layer however is not provided in a window insert. FIG. 6 depicts a polycarbonate (PC) structure being opaque. FIG. 7 likewise depicts a polycarbonate (PC) structure being opaque, which however furthermore comprises a lens structure.

### LIST OF REFERENCE SIGNS

1 data carrier
2, 2a, . . . substrate layer
3 processing layer
4 pigment
5 surface region
6 surface region
7 surface
8 surface
9 surface
10 surface
11, 11a, . . . surface
12, 12a, . . . surface
13, 13a background layer
14 security element
15 personalization element
16 lens structure
17 lens
18 top side
19 bottom side
20 top layer
21 bottom layer
22, 22a, . . . surface
23, 23a, . . . surface
24, 24a opening
E extension direction
T transverse direction
V vertical direction
H horizontal direction

1. A data carrier comprising:
at least one substrate layer; and
at least one processing layer,
wherein the substrate layer and the processing layer are arranged at least partially above one another with respect to an extension direction,
wherein the substrate layer is preferably at least regionally transparent,
wherein the processing layer comprises pigments that are configured to change an appearance, in particular a translucency and/or an opacity and/or a glossiness and/or a colour, upon an irradiation of electromagnetic radiation;
characterized in that one or more pigments have at least one selected from a group comprising of a flat shape or a disc-like shape or one or more pigments have an average diameter being larger than a thickness.

2. The data carrier according to claim 1, wherein the pigments are inorganic pigments and/or organic pigments and/or inorganic-organic pigments, and/or
wherein the pigments comprise or consist of one or more metals and/or of one or more oxides preferably metal oxides and/or of one or more alloys preferably metal alloys and/or of one or more ceramics, and/or
wherein the pigments comprise or consists of one or more of Al, Cu, Au, Ag, Ti, Zn, Sn, TiN, TiCN, CrN, ZrN, TiZiN, ZrCN, TiC, TiCrN, AlTiN, TiAlN, diamond like carbon, SiO₂, Al₂O₃, CeF₃, ZrO₂, CeO₂, ZnS, TiO₂, SiOₓN_{y} or combinations thereof, and/or
wherein the pigments comprise or consist of aluminium and/or brass and/or bronze and/or copper.

3. The data carrier according to claim 1, wherein the pigments are at least one selected from a group comprising of arranged in a surface region of the processing layer or wherein the pigments are arranged within the processing layer.

4. The data carrier according to claim 1, wherein at least one surface of a particular pigment is oriented parallel to a surface of the data carrier, in particular parallel to a surface of the processing layer and/or parallel to a surface of the substrate layer.

5. The data carrier according to claim 1, wherein the processing layer is at least one selected from a group comprising of printed or provided as coating or sprayed, or
wherein the processing layer comprises at least one ink, preferably a solvent-based ink or a curable ink and particularly preferably a printing ink, or
wherein the processing layer at least in an initial state comprises one or more dissolved polymers, or
wherein the processing layer is applied on the substrate layer or on a further layer such as a background layer.

6. The data carrier according to claim 1, wherein the substrate layer and the processing layer are at least one selected from a group comprising of in connection with one another or connected to one another via lamination, or
wherein the processing layer or the substrate layer are heat-resistant, preferably up to a temperature of at least 100° C. or more, preferably of at least 150° C. or more, particularly preferably of at least 180° C. or more.

7. The data carrier according to claim 1, wherein the substrate layer and the processing layer are arranged at least one selected from a group comprising of partially or completely overlapping with respect to the extension direction, or
wherein an expansion of the substrate layer along a transverse direction running perpendicularly to the extension direction and an expansion of the processing layer running along the transverse direction are the same or different from one another, or
wherein the data carrier comprises two or more substrate layers.

8. The data carrier according to claim 1, further comprising at least one background layer,
wherein the background layer is at least one selected from a group comprising of opaque or configured to at least partially reflect incident electromagnetic radiation or configured to at least partially absorb incident electromagnetic radiation, or wherein the background layer is arranged before or after or at a same location as the substrate layer or the processing layer with respect to the extension direction, or
wherein an expansion of the background layer along a transverse direction running perpendicularly to the extension direction and an expansion of the processing layer running along the transverse direction or an expansion of the substrate layer running along the transverse direction are the same or different from one another.

9. The data carrier according to claim 1, wherein the processing layer is part of or constitutes at least one selected from a group comprising of at least one security element or at least one personalization element,
wherein the security element or the personalization element preferably has the shape of an image or of an alphanumeric character.

10. The data carrier according to claim 1, further comprising at least one lens structure comprising one or more lenses, particularly preferably one or more lenticular lenses, and
wherein said lens structure is preferably configured to alter an appearance of the processing layer, in particular at least one selected from a group comprising of the security element or of the personalization element, or
wherein said lens structure is preferably configured to focus incident electromagnetic radiation.

11. A security document comprising or consisting of at least one data carrier of claim 1, the security document preferably being an identity card, a passport, a credit card, a smart card, a driving license, a data page or the like.

12. Use of a processing layer for the manufacturing of a data carrier, wherein the processing layer comprises pigments that are configured to change an appearance, in particular at least one selected from a group comprising of a translucency or an opacity or a glossiness or a colour, upon an irradiation of electromagnetic radiation.

13. A method of producing a data carrier of claim 1, the method comprising the steps of:
providing at least one substrate layer; and
providing at least one processing layer,
wherein the substrate layer and the processing layer are arranged at least partially above one another with respect to an extension direction,
wherein the substrate layer is preferably at least regionally transparent,
wherein the processing layer comprises pigments that are configured to change an appearance, in particular at least one selected from a group comprising of a translucency or an opacity and/or a glossiness or a colour, upon an irradiation of electromagnetic radiation;
wherein one or more pigments have at least one selected from a group comprising of a flat shape or a disc-like shape or one or more pigments have an average diameter being larger than a thickness.

14. A method of personalizing a data carrier or of producing a security element in a data carrier, the method comprising the steps of:
providing a data carrier of claim 1, and
irradiating electromagnetic radiation onto the data carrier so as to change the appearance, in particular at least one selected from a group comprising of the translucency or opacity or glossiness or a colour of the pigments.
